(19) United States
(12) Patent Application Publication
(10) Pub. No.: US 2025/0201146 A1
(43) Pub. Date: Jun. 19, 2025

(54) CONTEXTUAL VEHICLE EVENT PROCESSING FOR DRIVER PROFILING

(71) Applicant: I4D LTD., Modiin (IL)

(72) Inventor: Adi GOREN, Jerusalem (IL)

(21) Appl. No.: 19/060,763

(22) Filed: Feb. 23, 2025

Related U.S. Application Data
(63) Continuation-in-part of application No. PCT/IL2023/050892, filed on Aug. 22, 2023.
(60) Provisional application No. 63/373,286, filed on Aug. 23, 2022.

(51) Int. Cl. G09B 19/16; B60K 35/28; B60W 40/08; B60W 40/09; G06F 16/338

(52) U.S. Cl. CPC G09B 19/167; B60K 35/28; B60W 40/09; G06F 16/338; B60W 2040/0818

(57) ABSTRACT

A computing system, for automated generation of instructional text for driver safety, executes steps including: 1) accessing predefined datasets of telematic alerts, of predefined alert sequences, and of sequence categories; 2) acquiring one or more alert vectors during driving, each alert associated with a time of occurrence; 3) scanning each of the one or more alert vectors, over multiple time windows, to identify a set of alert sequence occurrences matching alert sequences in the sequence dataset and conforming to predefined time windows; 4) according to the severity of each alert sequence in the identified set of alert sequences, increasing by a proportional amount a priority score of a corresponding sequence category, to generate an aggregate priority score for each sequence category; and 5) providing instructional text associated with said sequential category from a text dataset to the driver.

### CROSS REFERENCE TO RELATED APPLICATIONS

This application is a Continuation-in-Part (CIP) of international application PCT/IL2023/050892, filed Aug. 22, 2023, which claims the benefit under 35 U.S.C. 119 (b) to U.S. Provisional Patent Application No. 63/373,286, filed Aug. 23, 2022, both of which are hereby incorporated by reference.

### FIELD OF THE INVENTION

The invention relates generally to systems and methods for improving driver training.

### BACKGROUND

Vehicle accidents cause injuries and loss of life, as well as property damage to vehicles and structures. Fleet operators suffer losses as injured drivers cannot work and damaged vehicles cannot be driven. Consequently, programs may be instituted to monitor driver performance and to institute driver reviews and training to improve driver safety and reduce accidents.

Different telematics solutions are available on the market for monitoring a driver's handling of a vehicle (i.e., “vehicle handling”). These solutions can be classified into two main categories: 1) “Dry sensor” systems, which collect data related to speed, acceleration, deceleration, and turning; and 2) more advanced systems, such as advanced driver-assistance systems (ADAS) and driving monitoring systems (DMS), which combine dry sensors with safety systems (e.g., Mobileye®), which typically include in-cabin and external cameras. In-cabin cameras may be used for monitoring driver motions that indicate driver distraction. External cameras can monitor the vehicle environment, providing alerts related to lane changes, vehicle-to-vehicle distances, pedestrian crossings, intersections, etc. The sensors may also include a GPS system for monitoring a vehicle location. Such systems may also include video telematics, which may combine a dry sensor system with a standard recording dash cam.

Most telematics-based systems collect data and provide information regarding vehicle handling alerts, that is, events indicating non-standard vehicle operation, such as harsh braking or harsh cornering, etc. A customer of such information is typically a fleet manager or insurer, who receives the information and uses it in programs that assess drivers. However, such methods of assessment are often considered to be poorly correlated to driver skills. Improved driver evaluation can improve the results of driver coaching and training programs.

### SUMMARY

Embodiments of the present invention provide a system and methods for generating “contextual” insights regarding driver skill, determining optimal driver training (i.e., coaching) based on identification of alerts and events, and sequences of alerts.

While a vehicle is being driven, the system receives a series of alerts, that is, a series of recorded data from the vehicle telematics and/or driver monitoring systems. Such a series is called an alert stream or alert “vector.” The alert vector may include sequences of alerts that are known to be risky. For example, when a driver approaches a traffic light junction a sequence of alerts indicative of risk may include: 1) the vehicle speed; 2) a yellow traffic light at the junction; 3) a pedestrian collision warning (PCW); 4) harsh braking; 5) harsh cornering; and 6) full stop. The system automatically checks if such a sequence is listed in a predefined dataset of sequences, applying predefined timing windows to check for matches between the alerts and the predefined sequences. If the sequence exists in the dataset, an occurrence of the sequence is recorded, together with attributes of the sequence, such as severity and risk level.

On every driving trip over a given period of time, the vector of alerts for the trip is recorded and scanned with sliding time windows to determine sequences performed by the driver. At the end of a given analysis period, detected sequences are grouped according to their relevant instruction category. An aggregate priority and severity level of each category is calculated. An automatic instruction report is then generated for the categories with the highest priority level. A personalized instruction report is provided, including professional driving guides that are prepared in advance for each driving category and predefined in an instructional dataset.

The system may also determine a driver profile, presenting a highest correlated driver profile category as a primary profile and presenting a second highest correlated driver profile category as a secondary profile, wherein the primary profile and the secondary profile create a weighted profile.

The system may also present a driver risk factor, calculated based on the risk associated with each alert in the sequences that were detected by the system.

### BRIEF DESCRIPTION OF DRAWINGS

For a better understanding of various embodiments of the invention and to show how the same may be carried into effect, reference will now be made, by way of example, to the accompanying drawings. Structural details of the invention are shown to provide a fundamental understanding of the invention, the description, taken with the drawings, making apparent to those skilled in the art how the several forms of the invention may be embodied in practice.

In the accompanying drawings:

FIG. 1 is a schematic illustration of a system for driver profiling and automated instruction generation, according to some embodiments of the present invention;

FIGS. 2A and 2B are respective exemplary predefined datasets of alerts and alert sequences, according to some embodiments of the present invention;

FIG. 3 is a flowchart of generating a sequence and associated attributes from a series of alerts, according to some embodiments of the present invention;

FIG. 4 is a table of sequence pattern categories (also referred to herein as “sequence” or “instructional” categories) to which sequences may be associated, according to some embodiments of the present invention;

FIG. 5 is a flowchart of a process for driver profiling and automated instruction generation, according to some embodiments of the present invention;

FIG. 6 is a table of examples of instructive text associated with each sequence pattern category, according to some embodiments of the present invention;

FIG. 7 is a table of examples of sequence occurrences, instructive text associated with each problem category, according to some embodiments of the present invention;

FIG. 8 is a flowchart for establishing one of four sectors of a driver profile as a primary profile, according to some embodiments of the present invention;

FIG. 9 shows two stages of the calculation of a driver profile, according to some embodiments of the present invention;

FIG. 10 is a 4-quadrant graph indicating four profiles, R, I, S, and C of driver behavior, and calculation of a weighted driver profile, according to some embodiments of the present invention;

FIG. 11 is a graph indicating a process of a connectivity search of sequence and alert factors for automated sequence detection; and

FIG. 12 is a diagram of connection/relation identification for automated sequence detection.

### DETAILED DESCRIPTION

Systems that combine dry sensors and Advanced Driver Assistance System (ADAS) capabilities, together with safety monitoring devices (e.g. Mobileye®) can provide safety alerts in addition to alerts related to vehicle operation. Safety alerts may include, for example, a headway distance warning, a forward collision alert, a pedestrian collision alert, etc. Additional alerts may be provided by a Driver Monitoring System (DMS), which may provide distraction and drowsiness-related alerts.

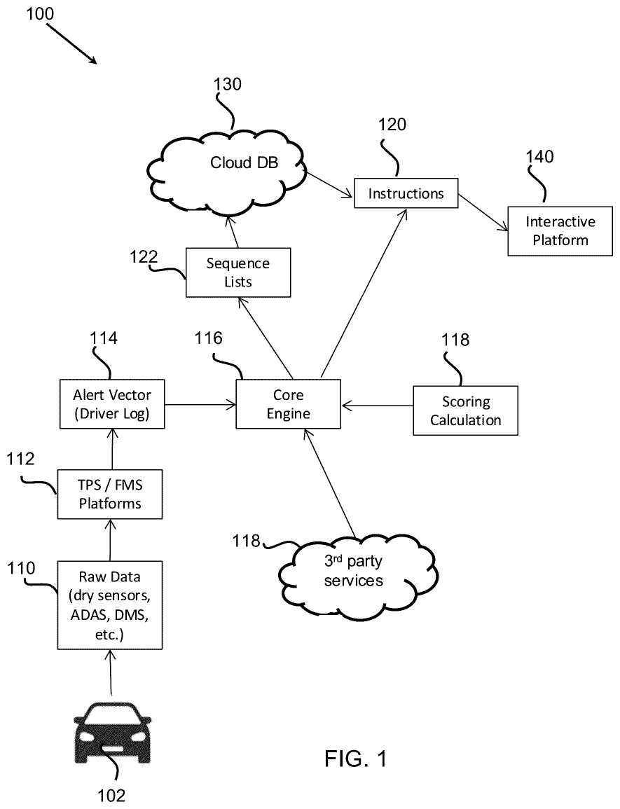

FIG. 1 is a schematic illustration of a system 100 for driver profiling, according to some embodiments of the present invention. Associated with a vehicle 102 is a set of sensors 110, which may include “dry sensors” (inertial and location sensors), as well as sensors and cameras used by telematics systems, including ADAS and DMS applications. Cameras may include in-cabin cameras, which may be used for monitoring driver motions that indicate driver distraction, and external cameras, which can monitor the vehicle environment (lane changes, vehicle-to-vehicle distances, pedestrian crossing, intersections, etc.). Sensors of telematics systems may also include a GPS system for monitoring a vehicle location.

Sensor data is communicated from the sensors 110 to telematics platforms 112, which are typically provided by telematics service providers (TSPs) and/or fleet management systems (FMSs) that measure and which correlate sensor data with “events” of vehicle operation, such as braking, turning, pedestrian crossing alerts, etc.

The telematics platform 112 provide raw vehicle event data 114, also referred to herein as a stream of alerts or an alert vector to a core engine 116 of the system. The alert data typically include identifiers of vehicle speed, “hard braking,” ADAS alerts, DMS alerts etc. as well as identifiers of a vehicle location and a time stamp of the alert. The core engine, which associates successive alerts with each other, allows a deeper contextual analysis of each driving event. The core engine 116 may also provide additional context by correlating the timing and location of vehicle event data with external conditions, such as weather, road conditions, and map data (e.g., intersection crossings), which may be provided by 3^{rd} party systems.

In some implementations, the core engine 116 includes two key modules: a “ground truth” module and an artificial intelligence (AI) module or “engine.” The ground truth module stores a dataset of driver behavior and driver safety events denoted herein as predefined alerts, which indicate an element of risk such as poor driving performance or poor vehicle handling. The ground truth module also stores a predefined dataset of sequences of alerts, as well as correlations between alert sequences and sequence categories, described further below. Correlations are also stored associating sequence categories with driver profile definitions described below. The ground truth module may include two sub-modules, an Alert List module and a Sequence Combination Scheme. The Alert List module compares alerts received (i.e., occurrences) with predefined alerts, and associates the received alerts with attributes of the predefined alerts.

The core engine 116 also includes scoring algorithms 118 described further hereinbelow. The core engine 116 generates output that includes driving instructional text 120 (i.e., “coaching”) and sequence list and score output 122, primarily related to a determination of sequence categories and a driver profile. The output 122 is typically stored in a cloud database 130, which may apply the output to generating additional analytics for improving driver safety. Driving instructional text 120 may then be then directed to an interactive platform 140, primarily for driver instruction.

The AI engine (or “module”) of the core engine may be configured to apply the pre-defined lists and definitions to automatically detect and classify new sequences, as well as to create new scoring and driver profile definitions. The AI engine, described further below, may be trained to recognize specific sequences out of their context, for example, an HDW+HDW sequence may be considered as a lane change event.

The core engine database may include hundreds of different sequences, categorized by sequence category, while the AI module constantly identifies and classifies new sequences that expand the database. The core engine may also include the driver profiling module, described further below.

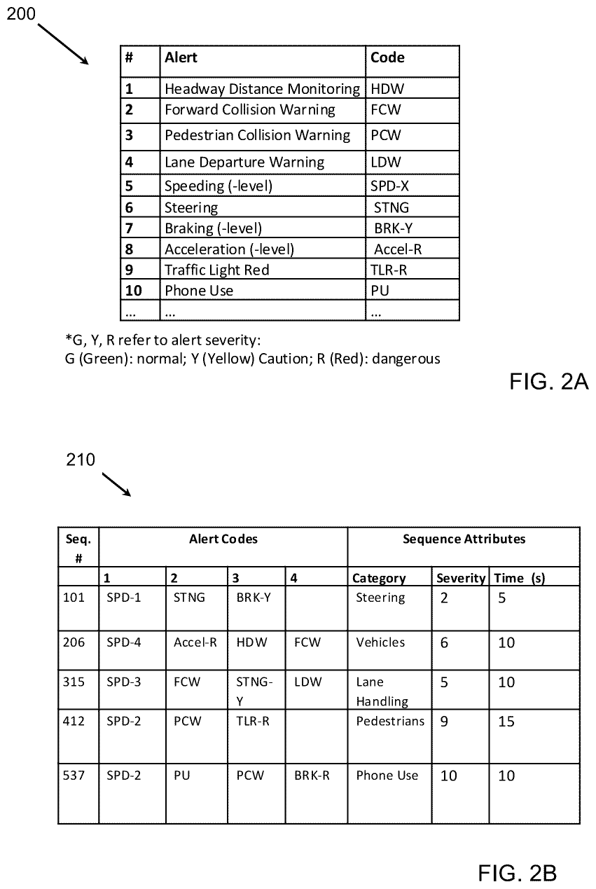

FIGS. 2A and 2B are partial examples of predefined datasets of alerts and alert sequences, indicated as tables 200 and 210 respectively. Table 200 shows some of the alerts that may be used by the system, including:

| | |
|---|---|
| Headway Distance Monitoring | HDW |
| Forward Collision Warning | FCW |
| Pedestrian Collision Warning | PCW |
| Lane Departure Warning | LDW |
| Speeding (-level) | SPD-Y⁴ |
| Steering | STNG |
| Braking (-level) | BRK-Y |
| Acceleration (-level) | Accel-R |
| Traffic Light Red | TLR-R |
| Phone Use | PU |

G, Y, R refer to alert severity:
G (Green): normal;
Y (Yellow) Caution;
R (Red): dangerous.

FIG. 2B is a table 210 showing a series of alerts, indicated as “alert codes,” and associated attributes stored with the sequence dataset. Attributes include instructional (i.e., sequence pattern) category, severity, and time window. The first sequence, for example, is a sequence 101 that includes the series of alerts: SPD-1 (speed level 1), a steering alert (STNG) and a mid-level (“Y”) braking alert. The severity of such a sequence is indicated as 2, and the maximum time duration over which the sequence occurs is indicated as 5 seconds. The sequence category is indicated as the “Steering” category. Note that there is no limit to the length of sequences, but they typically include between two and four alerts.

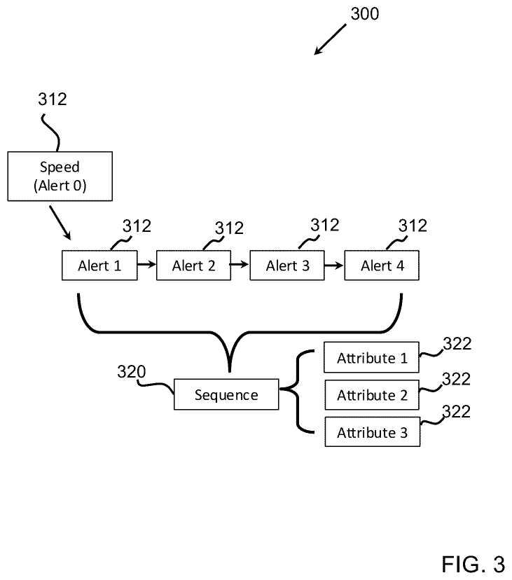

FIG. 3 is a flowchart of a process 300, generating, from a series of alerts 312, a sequence 320 and associated attributes 322. As described above, typical attributes are category, severity, and time duration. Additional attributes, as described further below, may include risk and profile, as well as a “close-call event.”

The algorithm of the core engine determines whether a sequence is classified as a “close call” event, meaning a sequence that had a high risk of leading to an accident. This is defined first as a sequence with a contextual speed above a 2nd level, as described further hereinbelow. Also, a close call includes an alert that belongs to a “driving behavior” category with an alert level of 2 or 3, and a technical alert such as hard braking or hard steering.

The algorithm determines the severity level by first calculating the sum of severity factors of each alert, taken from the alerts preset, and adding the severity factor of the sequence category, taken from the category preset. Next, a close-call event is taken into account and if the sequence is marked as a close-call event, the severity level is increased by multiplying it by a pre-defined factor. The severity level is normalized to be in the range of 1-10, where 1 is the lowest and 10 is the highest severity level.

Telematics systems typically provide a vehicle speed with each alert. However, the relation between speed and accident risk depends on the context of the event. A contextual speed refers to the driving speed of an alert with respect to the given situation (e.g., driving over a speed limit, where a high contextual speed in a school zone is lower than a high contextual speed on a highway). This is a more insightful parameter than the absolute speed as it provides direct information about the risk involved with the driving speed. To determine a contextual speed of a given sequence, a pre-defined table relates sequence categories and driving speed with a contextual speed. The contextual speed may be normalized between 1-4. The alert-1 in each sequence of FIGS. 2B and 3 is the contextual speed of the sequence, determined by the contextual speed of the first alert of the sequence.

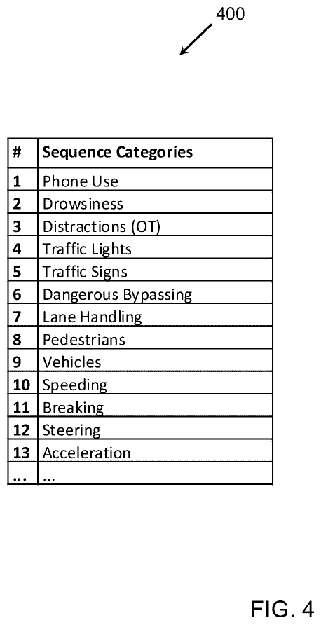

FIG. 4 is a table of sequence categories to which sequences may be associated. The categories are ordered with descending priority level, with Phone Use in the highest priority and acceleration with the lowest priority. As described above, a sequence is a combination of alerts, which may include alerts from one or more categories, and which may occur in different orders. A pattern matching algorithm may be applied to each sequence of alerts in a sliding time window, to determine if a sequence, or a sufficiently similar sequence, is defined in the sequence dataset. To facilitate the pattern matching of a sequence occurring during a drive with a sequence category, multiple sequencies may be defined in the sequence dataset as being associated with a single sequence category. The pattern matching algorithm is designed to be robust to non-relevant alerts that may occur within a sequence. For example, if a predefined sequence in the database includes ‘SPD-Y, HDW, BRK-R’ (speeding, headway warning, hard braking), the algorithm can identify this sequence even when additional alerts occur between these key alerts, such as ‘SPD-Y, LDW, HDW, PU, BRK-R’ where a lane departure warning (LDW) and phone use (PU) alert occurred during the sequence. This flexibility is important because drivers often perform multiple actions during a risky maneuver. Common pattern matching approaches suitable for this type of sequence detection include modified versions of the Smith-Waterman local alignment algorithm, which can identify subsequence matches while allowing for gaps, or Regular Expression (Regex) pattern matching, which can be configured to identify key alert patterns while allowing for intervening alerts. These algorithms can be configured to respect the maximum time window constraints, while still allowing for variation in the timing between successive alerts in the sequence.

As described further hereinbelow, each sequence category is also correlated with one or more driver profile attributes, to facilitate subsequent calculation of a driver profile.

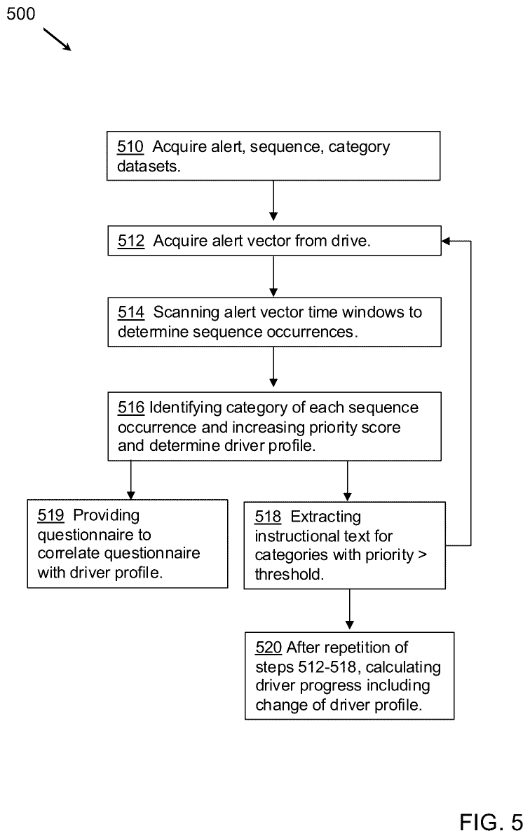

FIG. 5 is a flowchart of a process 500 for driver profiling and automated instruction generation. The process is typically performed on a general purpose computer having one or more processors and non-transient memory communicatively coupled to the one or more processors. Computer-readable instructions stored on the non-transient memory are executed to implement steps of the process 500.

At a first step 510, the system accesses predefined datasets including: an alert dataset of alerts that telematics and driver monitoring systems are configured to issue; a sequence dataset of alert sequences; a category dataset, each sequence category corresponding to one or more alert sequences, and a text dataset of instructional text associated with each of the sequence categories. Each alert sequence includes: a sequence of alerts from the alert dataset, a predefined timing window for a maximum duration of the alert sequence, and a severity of the alert sequence.

At a subsequent step 512, one or more alert vectors (i.e., data streams) are acquired from one or more vehicle telematics and/or driver monitoring systems (DMSs), while a vehicle is driven by a driver. Each alert vector is a series of alerts, each alert being associated with a time of occurrence. Typically, multiple drives a monitored, such that multiple alert vectors are aggregated.

Next, at a step 514, the system scans each of the one or more alert vectors, over multiple time windows across each alert vector. The scanning starts with each successive alert and identifies occurrences of alert sequences that match alert sequences in the sequence dataset and conform to the maximum predefined time windows of the respective alert sequences.

At a step 516, the sequence results are aggregated. The severity of each occurrence of a sequence increases by a proportional amount a priority score of a corresponding sequence category. After all sequences severity results are tabulated, the result is an aggregate priority score for each sequence category. In one embodiment, the severity scores for each sequence occurrence for each sequence category are simply summed together to provide the priority score for each sequence category. Alternatively, a weighted value is derived for the priority score of each sequence category, based on the severity of each sequence, and a driver profile may be determined from the aggregated results. A driver profile may be specified, that is, defined, by a weighted combination of driver traits, as described further hereinbelow.

At a step 518, the system may select from the text dataset, for each of the sequence categories having priority scores above a preset threshold, instructional text associated with the sequence category, or with the aggregated category results, which may be specified by the driver profile. The selected instructional text may be provided to the driver to improve driver skill and driving behavior.

At a step 519, each driver whose driving has been monitored and profiled may be given a questionnaire with multiple-choice questions, for the purpose of determining correlations between questionnaire responses and the driver profiles that have been determined. The correlation may be determined through various methods, for example, by generating a machine learning (ML) predictive model with a training dataset based on using the questionnaire responses by drivers and the drivers' corresponding profiles. It may be noted that the driver profiles may be further enhanced by taking into account external data, such as records of accidents, near-misses, and insurance claims related to drivers in the study. This data may come from insurance companies, fleet managers, or regulatory authorities.

The questionnaire given to the drivers in the study may include a combination of psychological and “tactical” questions. The psychological questions measure general aspects of relevant traits, typically with Likert-scale types of questions. For example, a question related to a drivers' risk aversion may be presented with the statement, “I prefer to avoid taking chances, even if it means missing opportunities.” Multiple choice alternatives questionnaire responses to such a statement may be: 1) Strongly disagree, 2) Disagree, 3) Neutral, 4) Agree, 5) Strongly agree. The “tactical questions present driving scenarios with alternative answers regarding how a driver would act in those situations.

Tactical questions may be presented with a statement related to a scenario, such as, “You are driving on a slippery road and a car suddenly stops in front of you.” Response options could be presented as: 1) I would brake hard, 2) I would steer to the side, 3) I would decelerate steadily, 4) I would hesitate before reacting.

Various statistical and machine learning processes may be applied to establish correlations between the driver profiles and questionnaire responses. These may include, for example:
Trait Clustering: Identifying clusters of drivers based on their profile traits (e.g., Aggressiveness, Timidity) and analyze patterns in their survey responses.
Behavior Correlation: Use multivariate regression models to correlate survey traits with specific telematics behaviors. For example, the trait “Aggressiveness” may correlate with high incidents of speeding and tailgating.
Risk Likelihood Analysis: Conduct logistic regression to determine the likelihood of accident involvement for each trait. For instance, drivers with high Aggressiveness scores may show a statistically significant 3x higher probability of being involved in accidents compared to low-Aggressiveness drivers.
Cross-Validation: Divide the dataset into training and testing subsets to ensure that the model accurately predicts accident likelihood in unseen data.
Weight Assignments: Traits with higher predictive power for accident likelihood are assigned greater weights in the final risk score computation.

After generation, the model correlating responses and profiles may be validated against a test dataset of additional questionnaire responses to ensure it meets a minimum prediction accuracy threshold. To improve prediction accuracy, the questionnaire may be updated to remove or modify questions that are poorly correlated with prediction accuracy. Questions showing strong statistical correlation with the driver profiles are preserved. This refinement continues until the questionnaire meets a level of correlation with driver profiles above a given correlation threshold, such as 90%.

Once validated, the questionnaire may be given to respondents whose profiles have not yet been determined during actual driving, as a means of predicting their driver profiles. Their responses can be processed, for instance, through the ML predictive model, to generate predictions of their driver profiles before their driving is actually monitored. Respondents' responses to both the psychological and the tactical questions are also evaluated for consistency to confirm honest responses. For example, if a respondent would be categorized as a “reckless” profile based on tactical questions, but an “insecure” profile given psychological traits, the system would flag the questionnaire responses for potential inconsistencies.

After multiple drivers have taken the questionnaire, the questionnaire may undergo continuous improvement and validation through various means, such as updating the training dataset with responses from additional profiled drivers and retraining the predictive models with the expanded dataset. This ongoing refinement process effectively designates drivers not only for types of instruction but, more generally, for driving assignments given behavioral tendencies and situational adaptability.

At a step 520, after repetition of the above steps, the system may also calculate “driver progress,” based on an aggregate score that takes into account an overall weighted measure of sequence severity. The progress may indicate driver improvement with respect to a driver profile. It should be noted that if alerts with high levels of severity (e.g., “red” behavior) are detected in an alert vector, but not found in the predefined dataset, sequences including these alerts may be added to the sequence dataset, after its attributes are calculated. The category is selected as the category of the high severity level. This allows the system to learn new driver behavior in an on-the-fly manner.

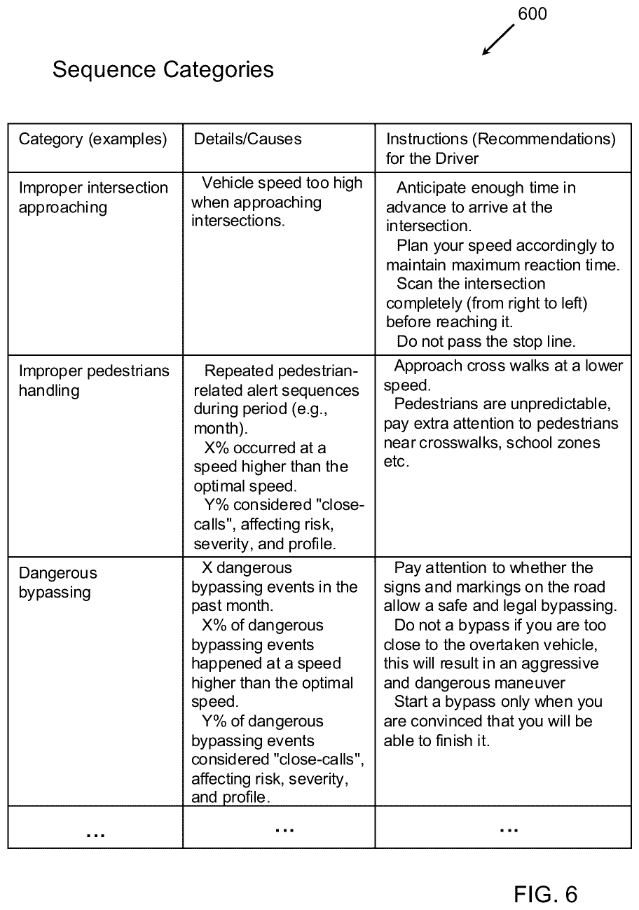

After collecting driving data for a period, such as one month, the system may automatically prepare a driving report with the driving instructions, as described above. The report may also indicate driving habits that are characterized by the sequences that occurred during the period. As described above, the driving report includes textual instructions that explain how to improve driving errors. FIG. 6 shows an exemplary report, indicating three sequence categories that had a high priority score (i.e., higher than the preset threshold), based on the severity of the sequences that occurred. As shown, the three categories were improper intersection approaching, improper pedestrians handling, and dangerous bypassing. The report indicates details of the occurrences that indicated the need for instruction in these areas. The report also includes a sampling of the type of instruction that would be given (which may also include live coaching and other instructional methods).

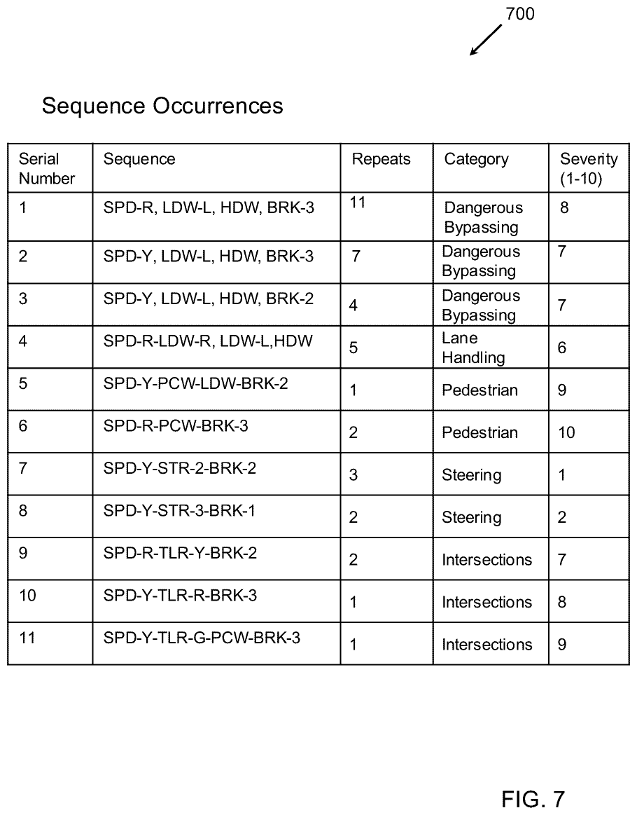

As indicated in FIG. 6, the highest priority category is “Dangerous bypassing.” FIG. 7 shows an example of the sequence occurrences that were applied to generate the category summary of FIG. 6. As indicated, over the course of the driving period, the driver was involved in multiple recurring sequences that related to dangerous bypassing. The first row of the table shows one particular sequence that was repeated 11 times. The recording of specific sequences helps the driver understand exactly what behavior he displays on the road and what needs to be corrected, with a level of detail that is not available when the system only records alerts.

The system may also include a driver profiling module, determining a “driver profile” based on the number and/or aggregate priority of the categories, as calculated above. A driver profile is an additional tool that provides feedback for the driver. Various statistical and machine learning processes may be applied to establish correlations between the sequence categories and driver profiles. The profile may be divided, for example, into four profile categories:
R-Reckless
I-Insecure
S-Skilled
C-Complacent

A model based on the categories above is referred to herein as the “RISC” Driver Profiling Model, or RISC Model. The RISC Model aggregates statistics of a driver's performance, style, and risk.

Each of the four RISC profiles is derived from driver alert sequences and behaviors, and is correlated with specific driver traits.

The system automatically creates driver profiles based on the data collected by the telematics system. The system then accumulates new data on a regular basis (e.g., bi-weekly or monthly) and monitors specific driving patterns that characterize each profile. Each profile is characterized by specific driving patterns and the probability of the driver being involved in a specific type of alert sequence. One of the key attributes for differentiating profiles is the speed that accompanies certain sequences. For example, an R-Profile will be involved in high speed, high aggressive driving patterns, while an I-Profile will be involved in low contextual speed, low-to-middle aggressive driving patterns. The profiles may be determined by a process that takes into account:
Driving patterns (i.e., sequence categories)
Repetitiveness: the number of repetitions of a specific pattern during a period of time.
Primary profile, Secondary profile and Weighted profile.
Severity factor: weighted severity score obtained from all sequences over time.
Risk factor: the risk is calculated by driving patterns/severity factor->specific close-call events->risk % (based on statistical research).

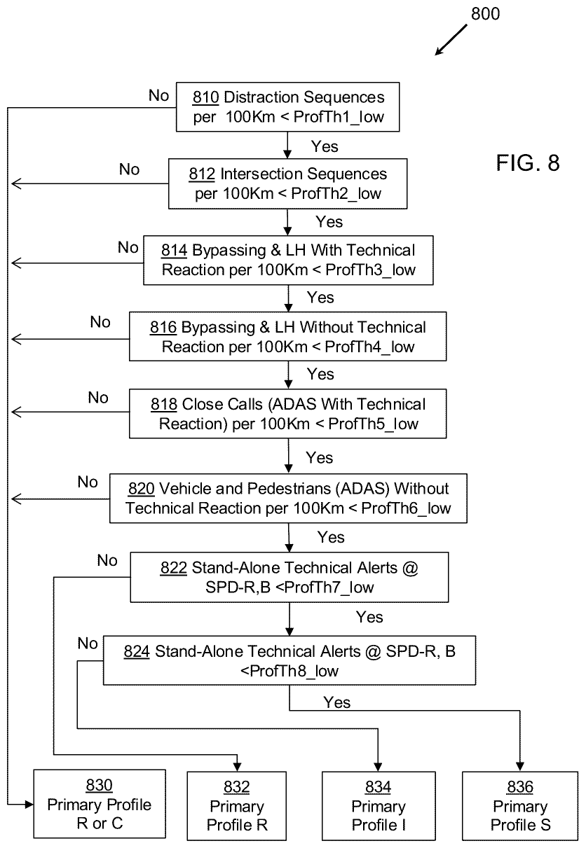

Primary and secondary profiles are determined based on the prevalence of different types of sequence occurrences. The total number of sequence occurrences under specific conditions during the relevant period (usually 1 month) are normalized (for example, per 100 km), and compared with a threshold. As indicated in the flow chart of FIG. 8, the different conditions are compared to thresholds in a specific order. If a driver fails any of the tests 810-812, meaning that the occurrence and/or priority level of any of the indicated categories is above a preset threshold, then the driver is assigned an R or C profile, i.e., the driver is risky or complacent. Failure of test 822 (SPD-R, B) indicates that the driver is an R profile. Failure of test 824 indicates that the driver is insecure. Finally, if the driver passes all of the tests, the driver gets the designation of a Skilled(S) profile.

In other words, there are four possible outputs for the flow chart: 1) R or C; 2) R; 3) I; 4) S. In cases 2-4 the process of primary profile detection ends at this stage. If the primary profile is either R or C, a weighted average as described below is used to calculate the weights of R and C, and the profile with the highest weight is the main profile. The secondary profile is determined by the same flow chart shown indicated in FIG. 8, but the threshold of each comparison is replaced with a different, higher threshold. The same procedure applies for the output “Secondary Profile R of C” as the one described for “Primary Profile R of C”. The two procedures described above provide both primary and secondary profiles. In order to determine the weighted profile, the relative weights of the primary and secondary profiles are calculated.

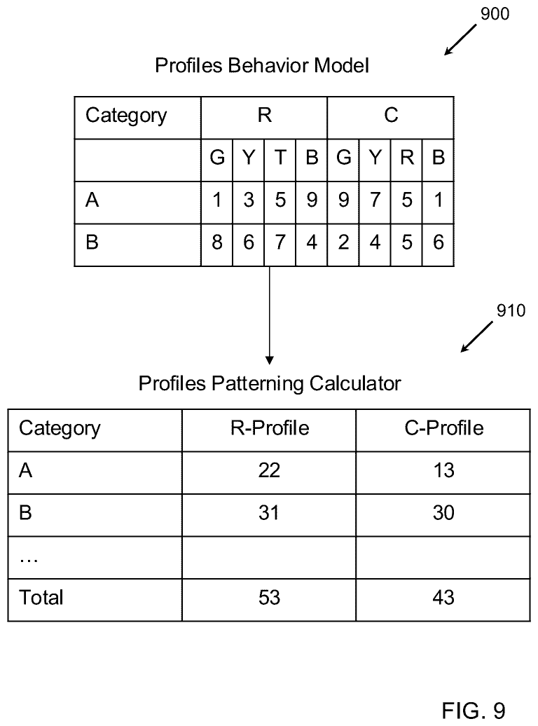

FIG. 9 shows additional scoring by a driving profile module to determine a position of an aggregate driver profile on an RISC grid, determined by calculating a relative score of primary and secondary profiles.

Scoring of profile categories may also include factors such as:
1. Attributes Scoring Scheme: the top attributes are considered for the severity factor.
2. Profile Behavior Model: the numbers represent a score (weights) from 1-10 for each category (driving pattern) to describe the probability of the profile to be involved in a specific category or driving pattern.
3. Profile Patterning Calculator: calculated as the number of sequences x in a month y. This method is used in cases where a profile is either C or R, as described above.
4. Severity factor: is applied in % according to a Severity Index (from Very Low to Very High), calculated by aggregating severity factors of all sequences.
5. Weighted profile: an average between Primary Profile and Secondary Profile
6. RISC Grid: the profiles will be automatically placed on the grid as described below.

Driver profiling is typically performed periodically, e.g., once a month (once sufficient data is collected) to indicate a driver's progress. An alternate procedure may be applied, as follows:
1. All sequences and speeding alerts from the relevant period are collected (stand-alone alerts, except for speeding, are excluded).
2. In each sequence the list of categories of the various alerts are collected.
3. A lookup table contains 4 weights (that stand for the 4 RISC attributes) related to each specific category at specific speeding.
4. The 4 weights are counted per each category that was found and are summed in the profile patterning calculator table (see below).
5. The counters of each profile in the patterning calculator table are summed to provide a total weight for each profile.
6. The profiles with the highest and the 2nd highest weight are selected as the primary and secondary profiles, respectively.
7. The weighted driver profile is a combination of the primary and secondary profiles given by the center of mass of the profile's weights.
8. Risk factor-statistical risk analysis based on literature research.

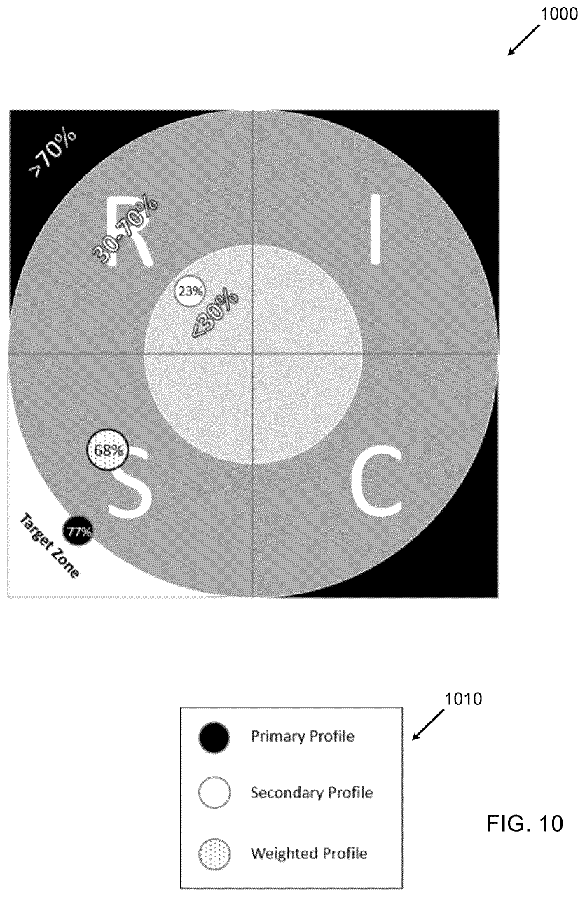

Primary and secondary profiles are plotted on a RISC grid 1000, as shown in FIG. 10. The weighted profile is found by the center of mass of the two main profiles, where the mass of each profile is given by its relative weight (indicated by the legend 1010). For example, given the scores shown in the figure:
R=23%
S=77%.

$$W = ( RR + SS ) / ( R + S ) = ( ( R \hat{} 2 ) R + ( S \hat{} 2 ) S ) / ( R + S ) = 68 \% S$$

The driver profile is initially calculated after one month (depending on the number of trips driven) and will be subject to monitoring and shifting over time. The customer will be able to track the course of his drivers' profile location and intensity on a monthly basis and understand the insights behind it in a simplified manner. For example, if the initial driver profile is a Strong R and after one month it is a Mild S, it means that the driver is improving fast. If it takes a long time for the driver to move from any profile to a S-Profile, the customer could verify if the insights provided by the system are understandable to the driver, if the coaching is efficient or whether there are any other reasons why the recommendations are not applied. In short, the goal of every driver is to reach the Target Zone: high intensity S-Profile.

### Calculating Risk Factors

The calculation of a driver risk factor is based upon contextual detection of every driving event. Every detected sequence is related to a specific driving category. For example, a sequence that includes a dangerous lane changing will be related to the Lane-Handling category. The total number of events in each category is summarized over the evaluation time period (e.g. 1 month). The sum of events in each category is multiplied by a factor that represents the risk associated with the particular type of event. The risk factor associated with each event is taken from scientific statistical study (e.g. https://www.pnas.org/doi/full/10.1073/pnas.1513271113). The driver risk factor is the sum of the risk factors associated with each category.

A “close call” event is considered as a sequence with medium, high or very high severity with a potential for an accident. The sequence must contain a yellow or red driving behavior alert such as hard braking or hard steering.

The risk factor is calculated on a monthly basis as an average of all Medium, High and Very High Severity sequences. A process for determining a risk score of a driver may be based on multiple sequences determined over the course of a given time period and includes the following stages:
1. Stage 1: the system constantly accumulates data on specific sequences, categories etc. with severity levels for close-call events.
2. Stage 2: the system counts the close-call sequences over time with their respective repetition rate, normalizes the data based on driven mileage and provides the probability of a sequence to repeat in a single trip or on a monthly basis.
3. Stage 3: in order to predict an accident, the system relies on formal research data.
4. Stage 4: the system performs a correlation between the general statistics and the individual historical performance of the driver in order to finetune the data, providing personalized statistic-based prediction.
5. Stage 5: the system performs a weighted calculation of the risk factor prediction based on all the information obtained in the previous stages.

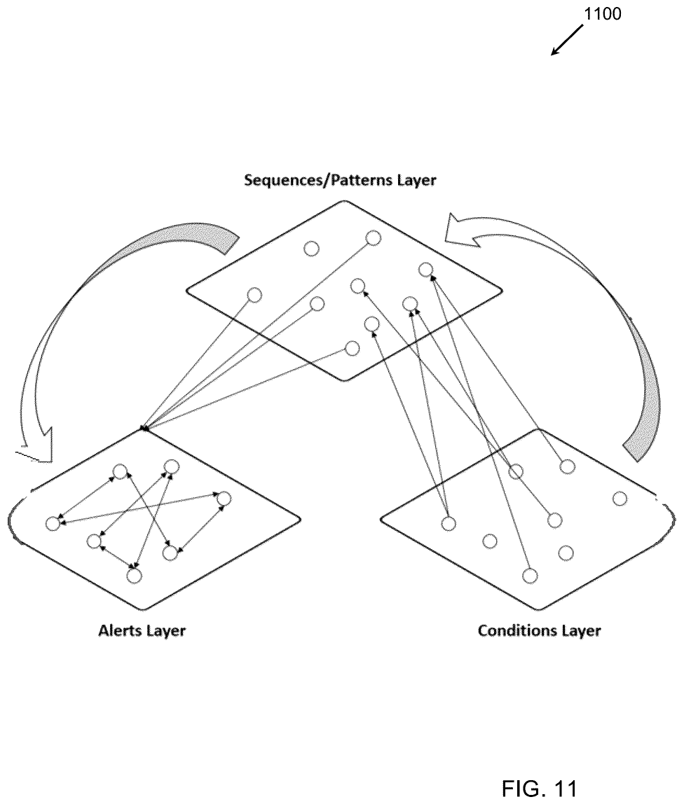

FIG. 11 shows relationships that may be applied by an AI engine process 1100 to identify new sequences. A layer refers to a group of datasets, for example, sequences in a Sequence Layer and alerts in an Alerts Layer. Each sequence contains two or more alerts. The algorithm performs a connectivity search of the alerts in every sequence, counting, for example, the number of times that an alert X appears in a sequence together with an alert Y, etc. Because each alert is also related to a category, the relations can be displayed on a level layer (relationship module 1), for example, the connection between distractions, forward collision and hard braking.

The algorithm also performs a connectivity search between one or more conditions/events (mechanical, weather and visibility, tires, etc.) and a specific sequence (relationship module 2). For example, a sequence #320, described above, may be classified as dangerous bypassing, and may be determined to be related a certain number of times per month to a low-pressure tire condition.

Each sequence has multiple attributes, such as severity, aggressiveness and violation factors, thus the relations can be displayed on a conditions layer, as indicated in FIG. 11. Relations can connect, for example, high severity sequences and limited visibility conditions.

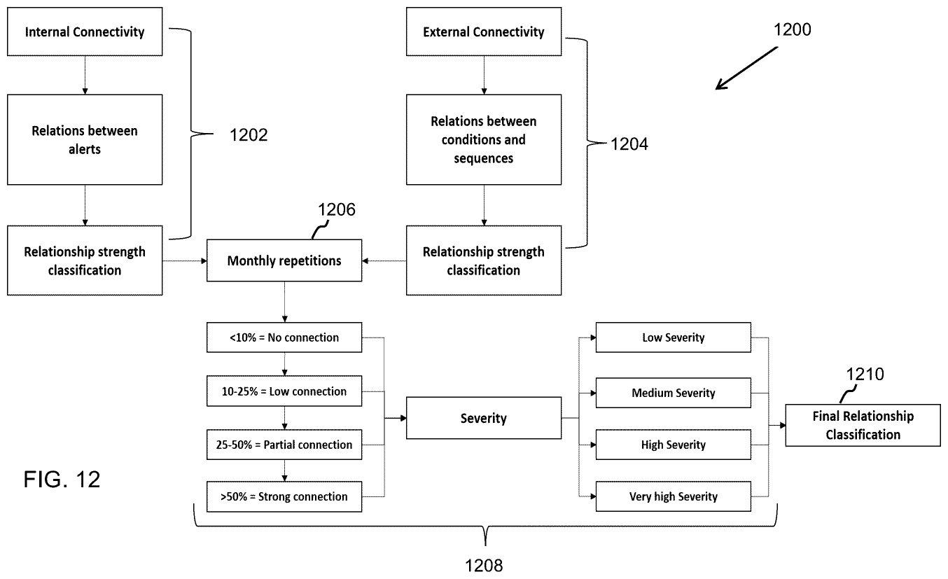

In a connection identification process the algorithm looks for connections in both internal and external connectivity and classifies them by patterning and severity factors as indicated in flowchart 1200 of FIG. 12.

A “connection” can refer to any alert in the same sequence, any sequence with any external condition (event), or any category or severity level. Typically, a connection is a given combination or ordered pattern of such factors in a sequence. The process of determining connectivity is based on the aforementioned rules, and has the following steps:
1. A “Relation” is defined as two or more factors in module 1 or module 2 described above (alerts, sequences, and conditions) that happen as part of the same sequence. A relation can be a connectivity between two or more such factors, identifying “internal” events (i.e., alerts) at a step 1202, or external events (i.e., conditions) at a step 1204.
2. When the algorithm identifies a connection between alert sequences that classifies the connection, it then counts the number of monthly repetitions at a step 1206.
3. The algorithm classifies the connection level as described in a Relationship Classification diagram. A connection level (%) may be calculated as follows: a number of times an alert or a sequence occurs alone, compared to the number of times it occurs as part of a relation (together with another alert or a condition).
4. The algorithm, at a step 1208, adds a severity factor to the sequence occurrence, based on the severity of the sequence in the dataset.
5. The system provides a final relationship classification at a step 1210.

The aforementioned processes refer to the driving data of a single driver. The system may also collect and process data for different groupings: drivers, profiles, fleets, and geographic areas. Big data processes may be applied to obtain broader insights for applications such as smart cities, autonomous driving etc. Steps of the process may include:
1. Each specific sequence enters an algorithm for counting occurrences for each of 4 types of groupings:
1.1. Driver Level: The algorithm determines prevalence of sequence connectivity for each set of driver level relationships, for example, for sequence #305, 75% of involved drivers are under the age of 47, males, with less than 25 years of driving experience.
1.2. Profile Level: The algorithm determines prevalence of sequence connectivity for each RISC Profile.
1.3. Fleet Level: The algorithm determines prevalence of sequence connectivity for types of fleets, for example, taxis, school buses etc.
1.4. Geo Level: The algorithm determines prevalence of sequence connectivity for geographic level, data and time, for example, urban area, specific intersection, night, state, country etc.
2. The system provides Filtered Relationship Classification, considering all the available alerts in the funnel.
3. The system takes all sequences' connectivity information and creates a Relationship Matrix that shows the extent of sequence connectivity to any level.

### EXAMPLES

A first example of the system for driver monitoring includes one or more processors as well as non-transient memory coupled to the processors. The memory stores several datasets: an alert dataset defining alert codes corresponding to signals that vehicle telematics and driver monitoring sensors are configured to generate, a sequence dataset storing predefined alert patterns that each include a specific ordering of alert codes with an associated maximum time duration constraint for pattern completion and a numeric severity indicator, a category dataset defining categories of sequences, and an instructional dataset containing text associated with each sequence category. The memory also stores computer-readable instructions that implement a process including:
receiving sensor-generated alert signals from one or more vehicle telematics systems for a given driver where each alert signal comprises an alert code and associated timestamp.
applying multiple sliding time windows over the alert signal streams to identify alert sequences and uses a pattern-matching algorithm to detect occurrences of the identified alert sequences in the predefined alert patterns, according to the associated maximum time duration constraint for each respective pattern, while identifying the sequence category of the detected pattern.
For each detected pattern, increasing by a proportional amount a priority score of the identified sequence category, according to the predefined severity, to generate an aggregate priority score for each sequence category for the given driver over a preset period of time; and
providing instructional text to the driver for each sequence category, according to the instructional text dataset, for sequence categories with priority scores above a preset threshold.

An example 2 of the system includes features of the first example, and presents the instructional text in order according to the aggregate priority score of the associated sequence category.

An example 3 of the system includes features of some or all of the above examples, and uses severity values that directly correspond to the risks of accidents or traffic violations.

An example 4 of the system includes features of some or all of the above examples, and calculates driver progress parameters on a recurring basis for the given driver while generating the aggregate priority score for each sequence category.

An example 5 of the system includes features of some or all of the above examples, and determines a driver profile with a weighted distribution of attribute categories according to preset correlations between the sequence categories and attribute categories as part of calculating the aggregate priority score.

An example 6 of the system includes features of some or all of the above examples, and uses attribute categories of reckless (Profile R), insecure (Profile I), skilled (Profile S), and complacent (Profile C), calculating primary and secondary ranked attribute categories according to the sequence category correlations.

An example 7 of the system includes features of some or all of the above examples, and provides a mapping of the primary and secondary ranked attribute categories of the driver profile on a grid of the reckless, insecure, skilled, and complacent (RISC) attributes alongside the instructional text.

An example 8 of the system includes features of some or all of the above examples, and selects drivers for driving assignments according to their driver profiles.

An example 9 of the system includes features of some or all of the above examples, and implements additional steps: determining driver profiles for multiple drivers, presenting a questionnaire about driving habits and attitudes to the multiple drivers and receiving their responses as a training dataset, generating a machine learning predictive model that correlates response patterns in the training dataset to the driver profiles. The system then presents the questionnaire to individuals whose driving has not been monitored and processes these responses through the ML predictive model to generate driver profile predictions for these individuals.

An example 10 of the system includes features of some or all of the above examples, and validates the ML predictive model against a test dataset of additional questionnaire responses to ensure a minimum prediction accuracy threshold.

An example 11 of the system includes features of some or all of the above examples, and updates the training dataset with responses from additional drivers and updates the ML predictive model using this expanded training dataset.

An example 12 of the system includes features of some or all of the above examples, and modifies the questionnaire by removing questions that have a low correlation to prediction accuracy.

An example 13 of the system includes features of some or all of the above examples, and identifies close-call events in the sequence dataset that have a high correlation with accident risk, providing these events to the driver alongside the instructional text.

An example 14 of the system includes features of some or all of the above examples, and associates time gaps between sequential alerts with each alert sequence, including time limits for these gaps in the sequence dataset.

An example 15 of the system includes features of some or all of the above examples, and processes alerts including vehicle speed, vehicle-to-vehicle distance, intersection approach, pedestrian distance, severe steering alerts, severe braking alerts, severe bypassing alerts, traffic light or traffic sign violations, forward collisions, accidents, and impacts.

An example 16 of the system includes features of some or all of the above examples, and monitors driver distraction indicators including phone use, drowsiness, smoking, eating, and drinking.

An example 17 of the system includes features of some or all of the above examples, and associates each alert in the stream with a location of occurrence, where each alert sequence in the sequence dataset includes road parameters and identifying alert sequences requires acquiring road parameters associated with the location of occurrence.

An example 18 of the system includes features of some or all of the above examples, and acquires alerts through post-processing video analysis of a video log of a drive.

An example 19 of the system includes features of some or all of the above examples, and acquires alerts as a log history containing multiple sequential alerts.

An example 20 of the system includes features of some or all of the above examples, and adds sequences to the dataset by using a pattern matching algorithm to identify alert sequences not currently in the sequence dataset that are relevant as driving behavior indicators based on their inclusion of alert and external event combinations similar to those in existing sequences.

It is to be understood that the scope of the present invention includes variations and modifications thereof which would occur to persons skilled in the art upon reading the foregoing description and which are not disclosed in the prior art. Although the invention has been described in detail, nevertheless, changes and modifications, which do not depart from the teachings of the present invention, will be evident to those skilled in the art. Such changes and modifications are deemed to come within the purview of the present invention and the appended claims. It will be readily apparent that the various methods and algorithms described herein may be implemented by, e.g., appropriately programmed general purpose computers and computing devices. Typically, a processor (e.g., one or more microprocessors) will receive instructions from a memory or like device, and execute those instructions, thereby performing one or more processes defined by those instructions. Further, programs that implement such methods and algorithms may be stored and transmitted using a variety of media in a number of manners. In some embodiments, hard-wired circuitry or custom hardware may be used in place of, or in combination with, software instructions for implementation of the processes of various embodiments. Thus, embodiments are not limited to any specific combination of hardware and software.

A processor as described herein may be any one or more microprocessors, central processing units (CPUs), computing devices, microcontrollers, digital signal processors, or like devices. Computer memory may be, but is not limited to, non-volatile media that may include, for example, optical or magnetic disks and other persistent memory. Transmission media may include coaxial cables, copper wire and fiber optics, including wires of a system bus coupled to the processor. Transmission media may include or convey acoustic waves, light waves and electromagnetic emissions, such as those generated during radio frequency (RF) and infrared (IR) data communications.

Sequences of instructions may be delivered from memory to the processor, may be carried over a wireless transmission medium, and/or may be formatted according to numerous formats, standards or protocols, such as Bluetooth, TDMA, CDMA, 3G.

Any illustrations or descriptions of arrangements for stored representations of information may be implemented by any number of arrangements, e.g., tables, files, or databases. Similarly, any illustrated entries of the stored data represent exemplary information only; one of ordinary skill in the art will understand that the number and content of the entries can be different from those described herein. Further, despite any depiction of stored data as databases or tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device which accesses such data.

The present invention can be configured to work in a network environment including a computer that is in communication, via a communications network, with one or more devices. The computer may communicate with the devices directly or indirectly, via a wired or wireless medium such as the Internet. LAN, WAN. Wi-Fi or via any appropriate communications means or combination of communications means.

1. A system for driver monitoring comprising:
one or more processors and non-transient memory coupled to the one or more processors and storing:
i) an alert dataset defining alert codes corresponding to signals that vehicle telematics and driver monitoring sensors are configured to generate,
ii) a sequence dataset storing predefined alert patterns, each pattern including a specific ordering of alert codes, an associated maximum time duration constraint for pattern completion, and a numeric severity indicator, and
iii) a category dataset defining categories of sequences,
iv) an instructional dataset of instructional text associated with each of the sequence categories, and
v) computer-readable instructions that when executed cause the system to implement steps of:
1) receiving, for a given driver, streams of sensor-generated alert signals from one or more vehicle telematics systems, each alert signal comprising an alert code and an associated timestamp;
2) applying multiple sliding time windows over the alert signal streams to identify alert sequences, applying a pattern-matching algorithm to detect an occurrence of the identified alert sequences in the predefined alert patterns, according to the associated maximum time duration constraint for each respective pattern, and identifying a sequence category of the detected pattern;
4) according to a predefined severity of the detected pattern, increasing by a proportional amount a priority score of the identified sequence category, to generate an aggregate priority score for each sequence category for the given driver over a preset period of time;
5) for each of the sequence categories having priority scores above a preset threshold, extracting instructional text associated with said sequence category from the text dataset and providing said instructional text to the driver.

2. The system of claim 1, wherein the instructional text is provided in an order, according to the aggregate priority score of the associated sequence category.

3. The system of claim 1, wherein the severity of each alert sequence is a value correlated with a risk of accident or with a risk of traffic violation.

4. The system of claim 1, wherein generating the aggregate priority score for each sequence category further comprises calculating driver progress parameters on a recurring basis for the given driver.

5. The system of claim 1, wherein calculating the aggregate priority score for each sequence category further comprises determining a driver profile with a weighted distribution of attribute categories according to preset correlations between the sequence categories and the attribute categories.

6. The system of claim 5, wherein the attribute categories are: reckless (Profile R), insecure (Profile I), skilled (Profile S), and complacent (Profile C), and wherein calculating the driver profile comprises calculating primary and secondary ranked attribute categories according to the sequence category correlations.

7. The system of claim 6, wherein providing the instructional text further includes providing a mapping of the primary and secondary ranked attribute categories of the driver profile on a grid of the reckless, insecure, skilled, and complacent (RISC) attributes.

8. The system of claim 5, wherein determining the driver profile further comprises selecting a driver for a driving assignment according to the driver profile.

9. The system of claim 5, wherein the computer-readable instructions implement further steps of:
determining driver profiles for multiple drivers;
presenting to the multiple drivers a questionnaire about driving habits and attitudes and receiving questionnaire responses as a training dataset,
generating a machine learning (ML) predictive model correlating response patterns in the training dataset to the driver profiles,
presenting the questionnaire to one or more individuals whose driving has not been monitored by the system and receiving their questionnaire responses; and
processing the questionnaire responses through the ML predictive model to generate driver profile predictions for the one or more individuals.

10. The system of claim 9, wherein generating the ML predictive model comprises validating the ML predictive model against a test dataset of additional questionnaire responses to ensure a minimum prediction accuracy threshold.

11. The system of claim 9, further comprising updating the training dataset with responses from additional drivers and updating the ML predictive model with the updated training dataset.

12. The system of claim 9, further comprising modifying the questionnaire to remove questions having a low correlation to prediction accuracy.

13. The system of claim 1, wherein a subset of the alert sequences in the sequence dataset are close-call events having a high correlation with accident risk and the steps further comprise providing the close-call events to the driver with the instructional text.

14. The system of claim 1, wherein each alert sequence is further associated with time gaps between sequential alerts and wherein the sequence dataset further includes time limits to the time gaps.

15. The system of claim 1, wherein the alerts include one or more of vehicle speed, a vehicle-to-vehicle distance, an intersection approach, a pedestrian distance, a severe steering alert, a severe braking alert, a severe bypassing alert, a traffic light or traffic sign violations, a forward collision, an accident, or an impact.

16. The system of claim 1, wherein the alerts include one or more driver distraction indicators including phone use, drowsiness, smoking, eating and a drinking.

17. The system of claim 1, wherein the stream of alerts is associated with a location of occurrence, wherein each alert sequence in the sequence dataset includes one or more road parameters, and wherein identifying each alert sequence further comprises acquiring one or more road parameters associated with the location of occurrence.

18. The system of claim 1, wherein the alerts are acquired in post processing, with video analysis of a video log of a drive configured to generate at least some of the alerts.

19. The system of claim 1, wherein the alerts are acquired as a log history including multiple sequential alerts.

20. The system of claim 1, wherein accessing predefined datasets further comprises adding sequences to the dataset by determining that an alert sequence not stored in the sequence dataset is relevant as an indicator of driving behavior, by determining by a pattern matching algorithm that the alert sequence includes combinations of alerts and external events similar to combinations in existing sequences.
